(19) United States
(12) Patent Application Publication
(10) Pub. No.: US 2005/0137904 A1
(43) Pub. Date: Jun. 23, 2005

(54) System and method for monitoring secured liens

(76) Inventors: Kathleen Lane, Los Gatos Hills, CA (US); William Lane, Los Gatos Hills, CA (US)

Correspondence Address: Patrick Reilly, Box 7218, Santa Cruz, CA, 95061-7218, US

(21) Appl. No.: 10/964,592

(22) Filed: Oct. 13, 2004

Related U.S. Application Data
(60) Provisional application No. 60/511,373, filed on Oct. 14, 2003.

(51) Int. Cl. G06F 17/60

(52) U.S. Cl. 705/1

(57) ABSTRACT

A secured lien monitoring system is provided that includes a tag affixed to property or documents, the tag communicating with a reader. The tag includes a memory for storing tag data, a transmitter and a receiver. The tag transmits and receives tag data to a reader in response to an interrogation request, or automatically. The tag data includes an identification number used to identify the tag associated with a particular asset and secured lien. The identification number in the tag may be an Electronic Product Code identification number assigned to a particular product or document. Information about the object to which the tag is attached may be described with a Product Markup Language. The lien monitoring system includes extending the Product Markup Language to manage Lien attributes used to monitor liens for specific collateral assigned and identified by an EPC and debtors. The EPC tag number may be used to point to secured lien information, including date filed, lien amount, lien filing number, recording fees, debtor information, creditor information, filing location, expiration date and other related information available locally or on a network.

### CROSS REFERENCE TO A CO-PENDING APPLICATION

This application is a Continuation to Provisional Patent Application No. 60/511,373 filed on Oct. 14, 2003, and which is incorporated herein by reference in its entirety for all purposes.

### FIELD OF THE INVENTION

The present invention relates to automated processes designed to monitor the status of secured transactions using RFID tags associated and attached to tangible and intangible property, documents and products described as collateral in such secured transactions. In particular, the patent optionally extends the Electronic Product Code (EPC) network and related EPC Product Markup Language to monitor secured transactions and secured liens. In addition, such tags can also optionally be affixed to the documents used to file, describe and record such secured transactions.

### BACKGROUND OF THE INVENTION

It is desirable to monitor whether property or other assets have recorded secured liens in existence. Before selling or disposing of tangible and intangible property, individuals and corporations should determine if a creditor has recorded a secured interest in a property before disposing of an asset.

Creditors follow government processes defined on how to file and record secured transactions against property, products and other assets. Such processes enable creditors to perfect their security interests which help manage and reduce their credit risks.

Creditors must know the proper location to file and the proper fees to be paid to record a secured lien, which vary depending on the location of the owner of the property, the location of the property, and the type of property. Some recordings are filed at a state level. Others are filed at a county level. If a record of the information entered on the UCC form is stored electronically, each filing location may maintain a separate database. Such database may use different database structures to store information about the creditor, the debtor and the collateral description. When completing the UCC form, it is extremely important to identify the debtor in a manner which allows subsequent searches to locate the recorded filing. For corporate filings, the filer must know the state the debtor resides in, the exact name the company registered with the state, as well as the organizational identification number assigned by the state. For individuals, the filer must be able to identify the correct state the debtor resides in.

These registered secured liens are indexed and stored in a filing system. Debtors, creditors and other third parties can pay a fee and request the owner of the filing systems to search these indexed files and report whether a secured lien is in effect for a specific debtor and a specific property. Requestors must know the location of the original filing to request the proper search for transactions filed for a particular debtor. In some instances, the approved registered filings are recorded in an electronic database and can be searched electronically. In other instances, a manual search of paper files may be done.

In the past, creditors file and record secured liens against a specific debtor, along with a description of the secured collateral, completing and filing Uniform Commercial Code (UCC) forms with designated state and local government recording offices. The recording office then reviews, approves and stores information about the recorded lien. Third parties then request a search of these files to discover whether a lien is in existence for a specific debtor or a specific asset.

Someone wanting to know if a lien has been recorded and is in effect for a specific debtor and specific collateral must spend time and dollars to request a search of databases in relevant states and counties to determine whether other creditors have filed and recorded a lien against a debtor and specific collateral. The requestor of the search must be careful to provide the exact name of the debtor in the state the corporate debtor has registered his corporation or the state an individual debtor lives in, or the search may be ineffective. The requestor of the search must also know whether to request a search at a state or local recording office.

Secured transactions in certain collateral described as Electronic Chattel paper may be perfected by placing a special electronic identification of the secured party on the original electronic copy of the chattel paper. Perfection is obtained by creating, storing and assigning the electronic records in a manner that preserves a single, authoritative copy that is unique, identifies the secured party's interest, is preserved by the secured party or its custodians, and which identifies any possible revisions.

In existing prior art, creditors lack processes to track the location of secured assets.

In existing prior art, documents used to describe secured collateral lacked a means to easily identify and track documents describing the collateral, or a means of authenticating a particular revision of a document describing collateral.

Furthermore, some database updates lag between the time a secured lien is filed and the time the secured database is updated. This delay would cause a request for secured liens to fail.

Instead of trying to track a complex and confusing combination of liens, objects, and creditors, in this Invention the new Electronic Product Code network is used to permit property owners to register and assign a unique identification code to a specific piece of property. All of the liens, timing of these liens, and creditor information will then be organized relative to this object, thereby simplifying the system and facilitating greater automation of the process. The Electronic Product Code is then stored on a radio frequency identification (RFID) tag which combines a silicon chip and an antenna and is attached to products. Once the EPC is read and retrieved from the RFID tag, it can be associated over a computer network with dynamic data stored on the network or in the tag such as the owner of the property using an Object Name Service (ONS). The ONS tells the computer systems where to locate information on the network about the object carrying an EPC. The Product Markup Languages (PML) is used as a common language in the EPC Network for describing physical objects.

The recording of liens against a specific property, (e.g., an electronic record, a physical object, a product) can now be coupled to a digital Electronic Product Code assigned to products.

The Electronic Product code network enables users to enter the EPC Code into a browser or to read the tag and automatically extract the EPC. When you scan an Electronic Product Code stored on an RFID tag, the serial EPC number read on the tag is sent to a computer that goes out over a network to the Object Name Service (ONS) which finds where information (PML or other data) associated with that EPC on the RFID tag is stored on the World Wide Web (the “web).

Computer processes may utilize the Product Markup Language, a variant of the Extensible Markup Language (XML) to define types of information maintained and available over the network about the product. PML files will be stored on servers, now called EPC Information services or PML Servers. The Product Markup Language enables additional data fields to be linked to the Electronic Product Code with users granted access rights to PML data fields for various automated processes.

The Core Product Markup Language (PML) defines shared common data fields about property, such as its name and serial number. The PML can be extended to link to additional information maintained about the product, such as the filing of a secured lien against the property.

Such EPC, ONS and PML technologies are accessible for integration into various types of automated systems and processes to store information related to a product, including a property name and serial number.

PML files can be hosted on secure severs, authenticate users and provide access to information about a particular property or debtor based on classes defined by the owners of PML files. A large manufacturer, for instance, might want to make some product information available to logistics partners but not to a supplier.

Therefore, it is desirable to provide a secured lien monitoring system that provides secured lien monitoring in a timely and cost effective manner.

It is also desirable to provide a secured lien monitoring system that makes it easy and immediate to determine if a secured lien is in place.

It is also desirable to provide a secured lien monitoring system that uses RFID tags to determine the specific location of property with secured liens.

It is desirable to extend the Electronic Product Code Markup network and Product Markup Language to monitor secured liens where the collateral described on a UCC filing has been assigned an EPC or other suitable product identification number or identifier known in the art.

It is also desirable to append information associated with a product on a network to automatically ascertain the owner of a product and a product type, i.e., real estate, to automate the correct submission and filing of UCC forms with the right recording office.

It is also desirable to enable third parties to use the EPC network and RFID tags affixed to property and documents to easily determine if a secured lien has been filed, providing a faster, more accurate, and more efficient method of determining if a secured lien is present than prior art enables. It is also desirable to use RFID tags to tag collateral or documents describing collateral when the collateral property has not been assigned an EPC.

It is desirable to link and monitor the status of secured liens against specific collateral identified with the Electronic Product Code by the direct association and linking of lien information using EPC technologies, enabling fast and efficient monitoring of secured liens.

It is desirable for a user requesting to know if a secured lien is in place to read the EPC stored in the RFID tag and access the Electronic Product Code network to search and locate secured liens. The use of the EPC network enables fast, accurate searches of a single network to located secured liens, as opposed to requesting multiple searches against multiple databases maintained by filing offices and other third parties.

It is desirable to tag the collateral documents using RFID to link and store information about the UCC filing, such as the filing location and filing date. Information in these tags can assist third parties with subsequent filing or searches related to secured liens.

It is desirable to use the EPC network, EPC technologies (the EPC, ONS, PML) and other computer networks to automatically determine the correct debtor information, the correct location and the correct fees required to complete and process a specific UCC form. Such network services may include automated process to request and receive information from various external databases containing accurate information about the debtor, including about the correct name, tax identification number and address. Such automated process may also notify the filer if such debtor information changes, sending an alert to the filer to file a new UCC form with updated debtor information. Such external data files may also maintain information on fees to file and search UCC records.

Thus a need exists for a secured lien monitoring system assisting in accurate, timely filings of UCC secured lien transactions by providing a tag, associated with a specific property or document that communicates tag data to an external reader. The present invention provides a way to quickly and positively read a tag, write to a tag, identify each tag and link to stored or external network information enabling the monitoring of secured lien transactions, including collateral or documents describing the collateral and UCC forms.

The present invention relates to new methods useful to a creditor, a debtor and other parties to correctly describe collateral and debtor information when completing a UCC form through the entering of an Electronic Product Code and linking the data entry process through the EPC network to validate and/or auto populate information identifying the collateral and the debtor.

The present invention also provides processes to extend the PML attributes to define, store and access information associated with a specific EPC to include information necessary to monitor secured liens. Third parties with proper access rights can access the EPC network to ascertain the status of liens.

The present invention also relates to the use of RFID tags to store and record liens for collateral which may not have been assigned an Electronic Product Code. Such RFID tags can be written to and attached or linked to collateral property or to documents used to define collateral. Such tags may be read by interested third parties to immediately ascertain if a lien is in effect or to determine if a document is the same document used as collateral description when the UCC was filed.

Such RFID tags may include a GPS chip that can be used by debtors, creditors and interested third parties to find and locate secured assets.

### SUMMARY OF THE PRESENT INVENTION

Towards this and other objects made obvious in the present disclosure, a first preferred embodiment of the method of the present invention provides a systemized process for recording and associating a secured lien record with a property and a debtor by utilizing an RFID tag and an Electronic Product Code system or other computer network. A Lien event, e.g. the creation of a lien against the property and the debtor, may optionally be captured as a Lien Attribute, where the Lien Attribute may become part of, or associated with, the Product Markup Language description of the property and the debtor. The Lien attribute may be captured and expressed in the EPC Product Markup Language (PML) in certain alternate preferred embodiments of the present invention, and such PML may include information about debtors, collateral, filing locations and filing fees.

The management of the Lien attribute, as optionally expressed by means of the Electronic Product Code Product Markup Language, may be effected through automated processes controlled and triggered by external events or the recording of an external event. External events may include the completion, submission, satisfaction and recording of liens on UCC forms, and other external events related to legal rights or responsibilities associated with the existence, nature or state of a lien.

In still alternate preferred embodiments of the method of the present invention, one or more of the capabilities may be providing;
Extending the PML or ONS product identification and definition public attributes with a private Lien attribute and optionally managing the Lien attribute(s) with the recording, amending and removal of UCC filings with state and local recording offices;
Accessing the EPC network using EPC technologies to validate and/or auto populate information about collateral, a filing location or a debtor when completing the collateral and debtor description on financial encumbrance documentation, to include UCC forms, and submitting such forms for processing;
Storing recorded lien information as both an attribute associated with the EPC network and as part of a smart label associated and/or attached to the property described as collateral or documents describing collateral used to complete the UCC forms;
Accessing a computer or communications network, the computer network optionally including the Internet and/or an EPC network and EPC technologies, to match/auto populate the name, address and organizational identification of the debtor entered in the UCC form with the data contained in state registration files.
Addressing a computer network, optionally including utilizing the EPC/ONS/PML lien attribute extensions, to identify the state to file a lien and whether to file a record of the lien at the state or local level depending on the owner of the property, the property type or a characteristic of the property;
The ability for (1) parties who originate and approve UCC documents and/or (2) third parties who search for liens to use the EPC network and/or an RFID tag attached to the property or UCC form used to record the filing to immediately ascertain lien status for a specific debtor or collateral;
The ability to request a search the EPC network using EPC technologies enabling linking Lien attribute information about collateral property and debtors to receive information about secured liens from a single source, depending on access rights and payment of any fees associated with such searches;
The use of RFID tags to tag documents used to describe collateral and attached to UCC filings to provide authentication of such documents and link such documents with a specific UCC filing;
The use of RFID tags affixed to submitted and processed UCC filings to track filing status such as location, date, fees paid, filing number, etc

The present invention overcomes the disadvantages of prior art by providing a system for easy identification and monitoring of secured liens by providing an RFID tag, associated with a specific collateral or document describing the collateral, that communicates tag data to an external reader. The present invention provides a way to quickly and positively identify each tag and store and read lien attributes. In particular, the systemized process accesses the Electronic Product Code network and utilizes EPC technologies to manage and monitor secured transactions.

The RFID tag data may optionally include any or all of the following: an identification number used to identify the tag associated with a particular collateral and debtor, an Electronic Product Code identification number, a Lien filing number, a Lien filing date, a Lien filing place, a Lien expiration date, a Lien filing fee, a Lien search fee, a creditor name, and/or a debtor name.

Certain yet alternate preferred embodiments of the method of the present invention provide an automated notification to a creditor or filer when an event occurs that affects a lien filed and stored with a recording office. For example, when a debtor changes Residence, such as a corporate headquarters or a personal residence, the debtor or designated filer may be obligated to file or re-file the lien with one or more government agencies to maintain the secured lien status.

The term property or collateral is defined to include an object, equipment, document, electronic record, service event, or other representation of a tangible or intangible entity, instance or.

### BRIEF DESCRIPTION OF THE DRAWINGS

These and other features of the present will be evident when considered in conjunction with the following Detailed Description of the Invention in which:

FIG. 1A is a schematic diagram of a communications network with which a first preferred embodiment of the method of the present invention may be executed.

FIG. 1B is a schematic diagram of a first preferred embodiment of the method of the present invention that provides a secured lien monitoring system, the system including an optional Module A of the system software of FIG. 1A, that enables the approval of a request to record or remove a secured lien by the completion and automatic forwarding of Uniform Commercial Code (UCC) forms to the correct recording office, and the subsequent recording of such lien in an RFID tag affixed to a particular property or asset;

FIG. 2 is a schematic diagram of a second preferred embodiment of the method of the present invention that provides an alternate secured lien monitoring system, wherein an optional Module B of the system software of FIG. 1A enables the recording of a state filing number and expiration data is affixed to or recorded in an RFID tag of FIG. 1A coupled with a printed UCC form, which then enables the user to easily file, associate and/or record subsequent lien actions including an amendment or removal;

FIG. 3 is a schematic diagram of a third preferred embodiment of the method of the present invention that provides a third secured lien monitoring system having an optional Module D of the system software of FIG. 1A wherein the property RFID tag of FIG. 1A includes an Electronic Product Code identifier (“EPC”) and the subsequent use of EPC methods and technologies to record a lien as part of an Electronic Product Code Network (EPCN”);

FIG. 4 is a schematic diagram of a fourth preferred embodiment of the method of the present invention that provides a fourth secured lien monitoring system wherein an optional Module E of the system software of FIG. 1A enables a secured lien to be recorded against a property where the description of the collateral of FIG. 1A includes a title that is associated with the recording of the lien;

FIG. 5 is a schematic diagram of a fifth preferred embodiment of the method of the present invention that includes an optional Module E of the system software of FIG. 1A and enables an individual user to determine if a lien exists against collateral identified with an EPC by using EPC technologies to accessing the Electronic Product Code Network of FIG. 1A;

FIG. 6 is a schematic diagram of a sixth preferred embodiment of the method of the present invention that comprises an optional Module E of the system software of FIG. 1A that enables an individual user to determine if a lien exists against a property by reading the RFID tag of FIG. 1A affixed or coupled to a property or document as a result of a secured lien transaction;

FIG. 7 is a schematic diagram of a seventh preferred embodiment of the method of the present invention employing an optional Module G of the system software of FIG. 1A that enables a debtor, creditor or other third party to determine the location of a specific asset or document describing the collateral asset where the RFID tag of FIG. 1A includes a GPS feature that can send information to a server when a tag is read to locate and track secured collateral;

FIG. 8 is a schematic diagram of an eighth preferred embodiment of the method of the present invention that includes an optional Module H of the system software of FIG. 1A that enables an originator of a lien transaction or record to utilize a computer network to validate the name, organizational identification, and address of the debtor by accessing databases of registered corporations, partnerships and LLCs; and

FIG. 9 is a schematic diagram of a ninth preferred embodiment of the method of the present invention that includes an optional Module I of the system software of FIG. 1A wherein an RFID tag is affixed to an electronic chattel paper and identifies documents associated with electronic records as the collateral source identified in the filings.

### DETAILED DESCRIPTION OF PREFERRED EMBODIMENTS

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims.

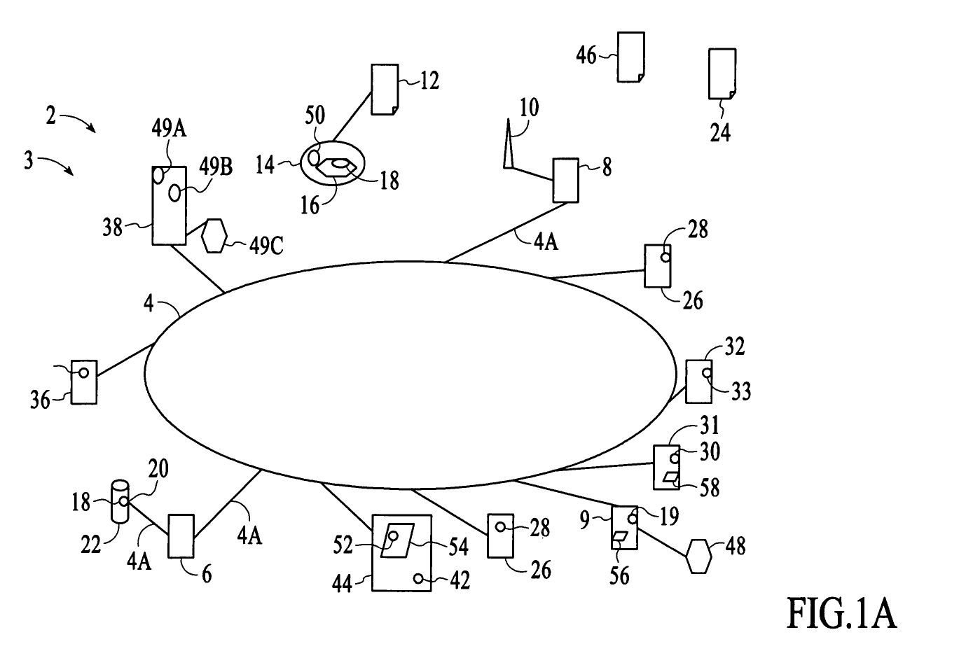

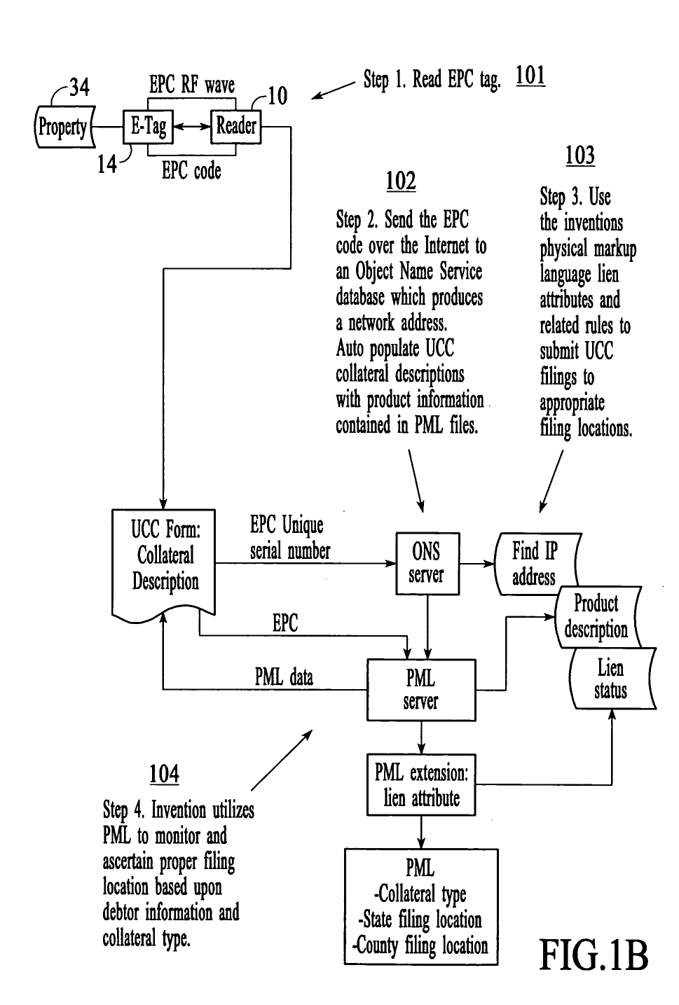

Referring now generally to the Figures, and particularly to FIG. 1A, FIG. 1A is a schematic diagram of a communications network 2 with which a first preferred embodiment of the method of the present invention may be executed. A communications network 2 comprises an Electronic Product Code Network (“EPCN”) 3, a computer network 4, and having a method to identify a database server 6, a user terminal 8, and an authority workstation 9. The database server 6, user terminal 8, and the authority workstation 9 comprise separate or shared computational engines capable of bidirectional communication with and by means of the computer network 4 and/or the communications network 2. The EPCN 3 and the computer network 4 alternatively comprise elements of each other, and/or are wholly or partially comprised within each other and/or the communications network 2, in various alternate preferred embodiments of the method of the present invention. The terminal 8 and the database server 6 are each communicatively linked to the computer network 4 by communications links 4A, which may be wireless links, landline links, or other suitable communications systems and modalities known in the art, in combination or singularity. The computer network 4 may be or comprise the Internet, an Intranet, an Extranet, and/or other suitable electronic communications networks known in the art. The terminal 8 may be or comprise an RFID reader 10, or may be communicatively linked to the RFID reader 10. A property 12 is coupled with an RFID device 14, or tag 14. The RFID device 14 has a memory 16 wherein an electronic product code 18, or EPC 18, is stored. A system software 19 stored in the authority workstation 9 comprises one or more Modules A through I (as described in FIGS. 1B through 9), where it is understood that in various alternate preferred embodiments of the present invention the system software 19 is distributed about one or more elements 6, 8, 9 of the communications network 2. The EPC 18 associates the property 12 with an EPC record 20 stored in a database 22 identifying the location of the data base server 6. A creditor or filer may associate a document 24, e.g., a lien 24 against the property 12 with the EPC 18 by informing the EPC network 20 of linked information identifying the document 24 (“lien 24”). In certain alternate preferred embodiments of the present invention information relating the lien may be stored in the memory 16 of the RFID device 14. The information relating to the lien and executed as part of the Product Markup Language may include an identification number used to identify the RFID tag associated with a particular property, an Electronic Product Code identification number, a Lien filing number, a Lien filing date, a Lien filing place, a Lien expiration date, a Lien filing fee, a creditor name, and/or a debtor name.

An ONS server 26 is communicatively coupled with the communications network 2, and is programmed with ONS software 28 that provides an ONS service to the communications network 2. The ONS software 28 may communicate via the communications network 4 with a PML server 30. An EPCN server 32 contains EPCN software 32 that provides EPCN service to the communications network 2. The EPCN service includes associating an EPC with other data related to a property 12 associated with the property 12, and making the EPC and the other data accessible to at least some users of the communications network 2.

Referring in particular to FIGS. 1A and 1B, and generally to the Figures, the communications network 2 may further comprise and/or employ other suitable communications methods and electronic communications systems known in the art, to include telephonic systems, data security systems and practices, and voice recognition systems to provide a systemized process for recording and associating a secured lien record with a property by utilizing an RFID tag 14 and optionally an Electronic Product Code system or network. A Lien event, e.g. the creation of a lien against the described collateral 34, may optionally be captured as a Lien Attribute, where the Lien Attribute may become part of, or associated with, the Electronic Product Code Product Markup Language description of the collateral. The Lien attribute may be captured and expressed in the EPC Product Markup Language (PML) in certain alternate preferred embodiments of the method of the present invention.

The management of the Lien attribute, as optionally expressed by means of the EPC, ONS server 26, and PML server 30, may be effected through automated processes controlled and triggered by external events or the recording of an external event. The term event is defined herein to include acts of recording data, signatures and legal information, as well as instances and passages of a time period. External events may include the completion, submission, satisfaction and recording of secured liens on UCC forms, and other external events related to legal rights or responsibilities associated with the existence, nature or state of a lien. The term lien is defined herein to include legally definable encumbrances any proprietary right of a property.

In still alternate preferred embodiments of the method of the present invention, one or more of the capabilities may be providing;
Extending the public PML product definition with a private Lien attribute and optionally owning and managing the Lien attribute(s) with the recording, amending and removal of UCC forms by state and local recording offices;
Accessing the EPC network to validate and/or auto populate information about collateral, the debtor or the filing location when completing the UCC forms;
Storing recorded lien information as both an attribute associated with the EPC network and as part of a smart label associated and/or attached to the collateral, documents describing the collateral and the UCC forms recording the lien.
Accessing a computer or communications network 2, the computer network optionally including the Internet and/or an EPC network and EPC technologies (the Electronic Product Code, Object Name Service (ONS), Physical Markup Language (PML) to match/auto populate the name, address and organizational identification of the corporate debtor contained in state registration files or individual debtors contained in various consumer databases.
Addressing a computer network 4, optionally including utilizing the EPC PML Lien attributes, to identify the state to file a lien and whether to file a record of the lien at the state or local level depending on the property type or a characteristic of the property;
The ability for (1) parties who originate and approve UCC documents and/or (2) third parties who search for liens to use the EPC network and EPC technologies and/or an RFID tag attached to the property to immediately ascertain lien status for unique collateral or a specific debtor;
The ability to use EPC technologies and the extended Lien attributes to readily ascertain the status of liens, replacing the requirement to do individual searches in multiple filing locations;
The use of RFID tags affixed to UCC filing documents to store information on the filing location and filing number and available for future amendment or removal of UCC filings;
The use of RFID tags affixed on documents attached with the UCC filing and used to define collateral at a specific point in time and to use such tags to link a specific document describing a specific list of collateral with the UCC filings;
A capability for a central server to optionally allow third parties access to the lien status data, where the authorized third parties have been given appropriate permissions.

The present invention thereby overcomes the disadvantages of prior art by providing a system for easy identification and monitoring of secured liens by providing an RFID tag, associated with specific collateral, specific UCC forms or specific documents describing the collateral, that communicates tag data to an external reader. The present invention provides a way to quickly and positively identify each tag and store and read the lien status. In particular, the systemized process accesses the Electronic Product Code network and uses EPC technologies to manage and monitor the Lien attribute linked with an individual EPC.

Referring now generally to the Figures, and particularly to FIG. 1B, FIG. 1B is a schematic diagram of a first preferred embodiment of the method of the present invention that provides a method to own and manage a secured lien monitoring system, the system including the approval of a request to record or remove a secured lien by the completion and automatic forwarding of Uniform Commercial Code (UCC) forms to the correct recording office, and the subsequent recording of such lien in an RFID tag affixed to a particular property or asset.

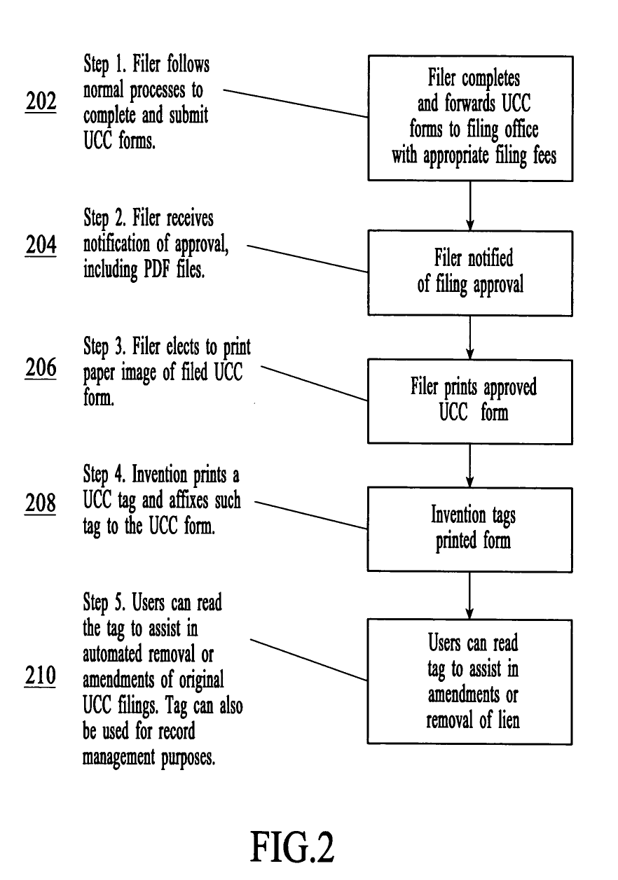

Referring now generally to the Figures, and particularly to FIG. 1B and FIG. 2, FIG. 1B is a schematic diagram of a second preferred embodiment of the method of the present invention that provides an alternate secured lien monitoring system wherein an optional Module A of the system software 19 enables a recording of a state filing number and expiration data is optionally affixed to or recorded in an RFID tag 14 on a printed form 24, which then enables the user to easily file, associate and/or record subsequent lien actions including an amendment or removal. In step 101 a property 34 with the tag 14 is read by the RFID reader 10, wherein an EPC and/or other data relating to the property 34 is harvested by the RFID reader 10. In step 102 the EPC and/or other data read from the tag 14 is transmitted via the communications network 2 to an Object Name Service of the computer network 4, wherein the Object Name Service (“ONS”) is at least partially hosted and executed by the data base server 6. The ONS then provides a network address, or other serial number related to the property, the data base server then creates a record populated with information available via the communications network 2 related to or associated with the property, wherein at least some of the information may be accessible via Product Markup Language documents or files (“PML”) accessible via the computer network 4. In step 104 the communications network applies and references the information provided to the database server 6 as related to or associated with the property to ascertain an encumbrance filing location, e.g. a UCC lien filing location, based upon the information concerning the debtor named in the encumbrance filing, and optionally the nature of the property.

Referring now generally to the Figures and particularly to FIG. 1B and FIG. 2, FIG. 2 is a schematic diagram of a second preferred embodiment of the method of the present invention that provides an alternate secured lien monitoring system, wherein an optional Module B of the system software 19 enables the recording of a state filing number and expiration data is affixed to or recorded in an RFID tag on a printed UCC form, which then enables the user to easily file, associate and/or record subsequent lien actions including an amendment or removal. In step 202 a filer, the filer being a human being or an automated software service, such as a web service or a software agent, substantively completes UCC lien form to record an encumbrance related to the property, and submits and delivers the filled out UCC lien forms to an authority, wherein the authority may be a governmental agency, court of justice, or private entity. In step 204 the filer receives authority notification of receipt of the submitted UCC lien forms via the communications network 2. This authority notification may include electronic documents, such as .pdf files, a notice of acceptance of the UCC lien forms, and/or notification of a defect in the UCC lien forms as filed. In step 206 the filer prints the authority notification in hard copy, i.e. as visually observable text on a sheet of paper or other suitable print media known in the art. In step 208 a UCC tag 14 is coupled with the hard copy of the UCC lien forms as submitted, and or with at least part of the authority notification. Information regarding the property, such as an EPC, is stored on the UCC tag 14. In step 210 the RFID tag 14 can be accessed to assist in automated removal or amending of the UCC lien form filing by the filer (as per step 202), and/or of another record related to the property or the UCC lien form filing of step 202.

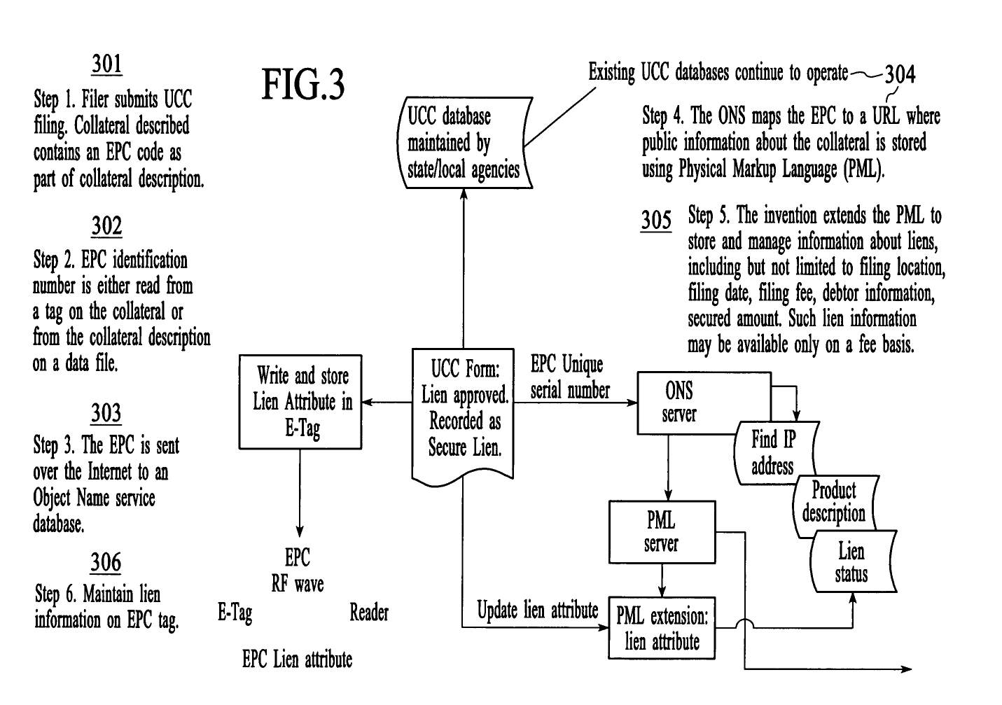

Referring now generally to the Figures, and particularly to FIG. 3, FIG. 3 is a schematic diagram of a third preferred embodiment of the method of the present invention that provides a third secured lien monitoring system wherein an optional Module C of the system software 19 enables access to information stored on the RFID tag 14 that includes an Electronic Product Code identifier (“EPC”), and a subsequent recording of such lien as part of an Electronic Product Code Network. In step 301 the filer summits a filing with an EPC associated with the property 12, 34, where the property 12, 34 may be referred to as “collateral” in the process of FIG. 3. In step 302 the EPC is accessed by reading the RFID tag 14 by means of radio wave communications and/or from data regarding the collateral 12, 34 provide from alternate data sources via the communications network 2 or otherwise accessible by suitable data access means known in the art. In step 303 the EPC is communicated via the computer network 2 to the ONS of the data server 6, or other suitable information technology system know in the art and communicatively coupled with the computer network 4. In step 304 the ONS maps the EPC to an associated universal resource locater (“URL”), the associated URL identifying a resource 6, 8, 22 of the computer network 4 where information is stored regarding the collateral 12, 34 and the information is accessible via PML. In step 305 the information stored regarding the collateral 12, 34 and the information stored at the same or another resource 6, 8, 22 of the computer network 4 is expanded, optionally by means of PML, to include additional information related to the collateral, including but not limited to encumbrance filing location, filing date, debtor information, secured amount(s) of financial value. This information may be provided by the filer or other third parties by means of the communications network 2, and may optionally be made accessible to interested parties via the communications network 2 on a no-fee, subscription, for-fee or financial charge basis. In optional step 306 information accessible via the communications network 2 may be stored on the RFID tag 14 by mean of the RFID reader 10, whereby the RFID tag 14 may be updated with new information related to or associated with the collateral 12, 34.

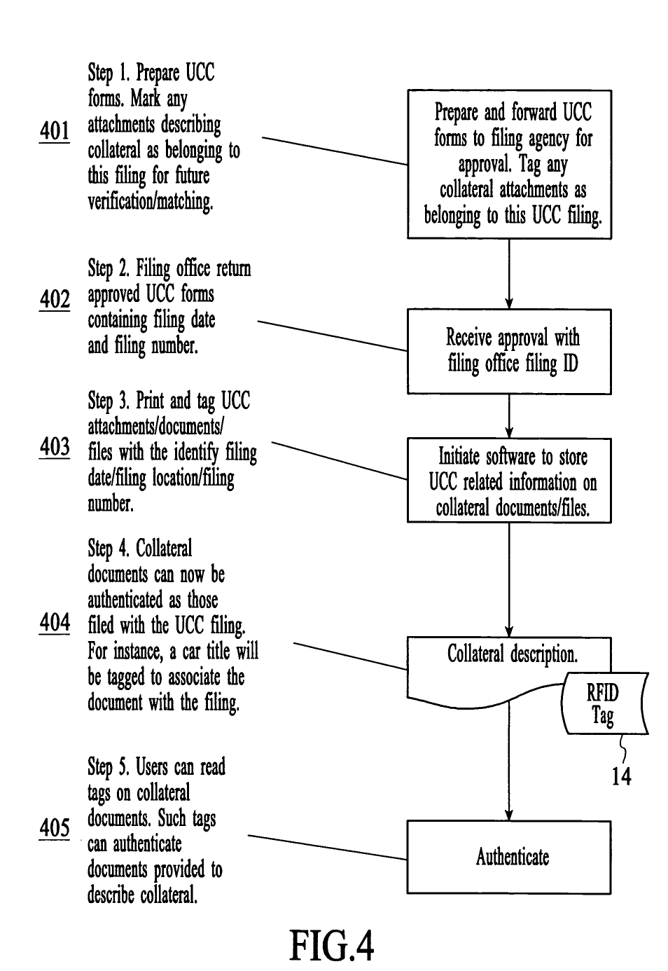

Referring now generally to the Figures, and particularly to FIG. 4, FIG. 4 is a schematic diagram of a fourth preferred embodiment of the method of the present invention that provides a fourth secured lien monitoring system comprising an optional Module D of the system software 19 wherein a secured lien is recorded against collateral 12, 34 where a title is associated with the collateral 12 described as part of the UCC filings and the RFID tag 14 links and associates such title with the filing document. In step 401 the filer prepares UCC forms for hard copy or electronic filing via the communications network 2 and selects and associates additional hard copy or electronic documents (“collateral documents”) with the collateral 12, 34. The filer then submits the UCC forms (as electronic documents and/or hard copies) with an authority. In step 402 the authority issues a receipt of the filing (as prepared as sent to the authority (“filing office”) in step 401, optionally with an authority notification. The authority notification is issued by the authority workstation 9 may include electronic documents, such as .pdf files, a notice of acceptance of the UCC lien forms, and/or notification of a defect in the UCC lien forms as filed. In step 403 the filer, or other party, may stores information related to the collateral 12, 34 on additional RFID tags 14 and couples or otherwise associates one or more of the additional RFID tags 14 with one or more of those additional hard copy or electronic documents associated with the collateral 12, 34 in step 401. In step 404 the collateral documents are associable with the filing of step 401, whereby, as an example, an electronic document or hard copy of an ownership title may be coupled or associated with an additional RFID tag 14, and the additional RFID tag 14 may be authenticated as being associated with the title, the UCC filing of step 401, and the collateral 12, 34. In optional step 405 third parties, such as users of the communications network 2, may be authorized and/or enabled to RFID tags 14 associated or coupled with one or more collateral documents, wherein an RFID tag 14 may be used by suitable means known in the art to authenticate one or more collateral documents.

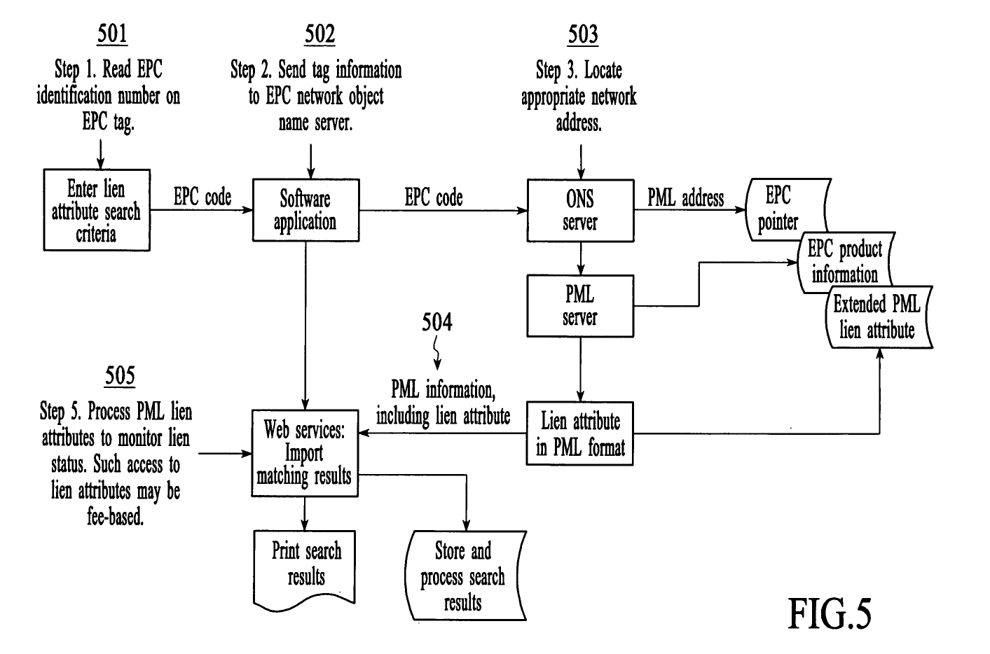

Referring now generally to the Figures, and particularly to FIG. 5, FIG. 5 is a schematic diagram of a fifth preferred embodiment of the method of the present invention comprising an optional Module E of the system software 19 that enables an individual to determine if a lien 24 exists against, or is associated with, collateral 12, 34, where the collateral 12, 34 is assigned and identified by a unique EPC code. According to the method of FIG. 5, using suitable EPC technologies known in the art, and accessing the secured lien information associated with the EPC and stored within the Electronic Product Code Network 3, a user may harvest and optionally option information related to the collateral 12, 34 and/or stored on the RFID tag 14. In step 501 a user reads an EPC from either the RFID tag 14 or from other documentation, and queries the EPCN with the EPC of the collateral 12, 34. In step 502 the EPC is communicated via the communications network 2 to the ONS server 26. In step 503 one or more network addresses (e.g., one or more URL's and/or PML server 30 network addresses) associated with the EPC are provided by the ONS software 28 and the ONS server 26 to the PML server 30. In step 504 the PML server 30 accepts lien attribute data and other information from the ONS server 26 and populates a PML formatted message with the lien attribute and other data. In step 505 a web service(s) server 36 receives the PML message via the communications network 2 wherefrom one or more web service may be implemented to accept and act upon, or make available, information contained in the PML message of step 504.

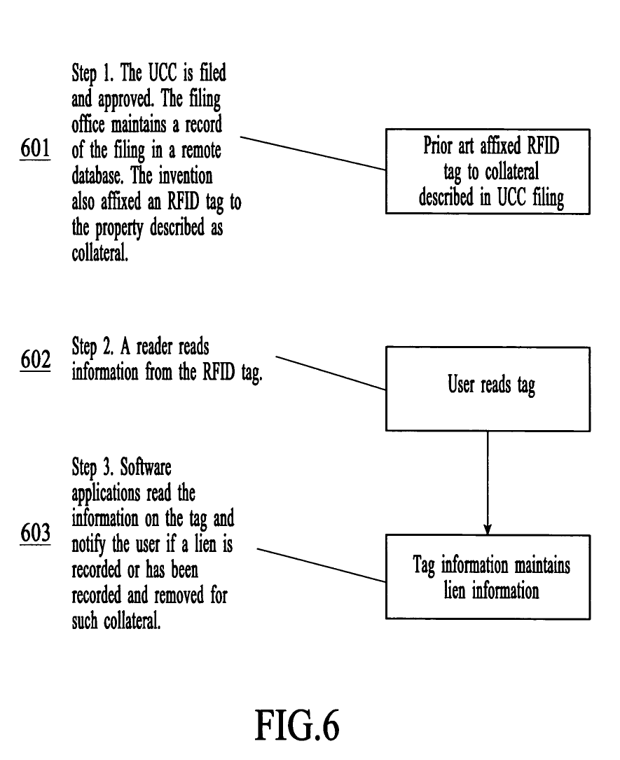

Referring now generally to the Figures, and particularly to FIG. 6, FIG. 6 is a schematic diagram of a sixth preferred embodiment of the method of the present invention that comprises an optional Module F of the system software 19 that enables an individual to determine if a lien 24 exists against specific collateral 12, 34 by reading an RFID tag 14 affixed to the collateral 12, 34 or a document associated with the collateral 12, 34. In step 601 the UCC form(s) are filed with an authorized server 38 of an authority, such as a governmental or court registry. The authority computer 9 maintains a record of the filing within the communications network 2, a remote database 42 of a remote server 44 and/or a computer-readable media 46. The RFID tag 14 is physically coupled (e.g., affixed) to the collateral 12, 34. It is understood that the remote server 44 and the computer-readable media 46, and a media reader 48 are comprised within the communications network 2. The media reader 48 is configured to read from and optionally write to the computer readable media 46. In step 602 the reader 10 reads the RFID tag 14, then accesses the information of the filing of step 601, and other accessible information, as stored in the communications network 2, and the system software 19 then in step 603 determines if the collateral 12, 34 related to information stored on the RFID tag 14 is associated with any lien 24, and informs the user of the results of this determination. The reader 10 may optionally update the RFID tag 14 by providing information harvested by the system software in step 603 for storage in the RFID tag 14.

The term “computer-readable medium” as used herein refers to any suitable medium known in the art that participates in providing instructions to the network 2 for execution. Such a medium may take many forms, including but not limited to, non-volatile media, volatile media, and transmission media. Non-volatile media includes, for example, optical or magnetic disks, such as storage device 10. Volatile media includes dynamic memory. Transmission media includes coaxial cables, copper wire and fiber optics. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to the network for execution. For example, the instructions may initially be carried on a magnetic disk of a remote computer. The remote computer can load the instructions into its dynamic memory and send the instructions over a telephone line using a modem. A modem local to or communicatively linked with the network can receive the data on the telephone line and use an infra-red transmitter to convert the data to an infra-red signal. An infra-red detector can receive the data carried in the infra-red signal and appropriate circuitry can provide the data to the network.

It is understood that in various alternate preferred embodiments of the present invention the system software 19 is distributed about one or more elements 6, 8, 9, 26, 28, 30, 32, 36, 38 & 44 of the communications network 2. Computers, workstations and servers 6, 8, 9, 26, 28, 30, 32, 36 & 38 each includes a first processor 49A and an optional second processor 49B, and a read module 49C. The read module 49C is communicatively coupled with one or both the first processor 49A and the second processor 49B. The read module 49C is selected as compatible with the computer-readable media 44, whereby software code embodied in the computer-readable media 44 may be used by the computers, workstations and servers 6, 8, 9, 26, 28, 30, 32, 36 & 38 to program either or both the first processor 49A and the second processor 49B.

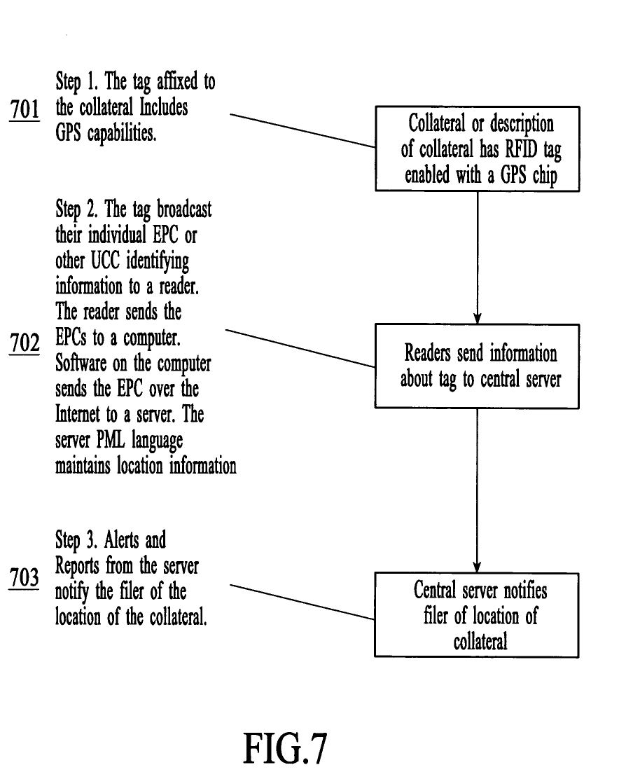

Referring now generally to the Figures, and particularly to FIG. 7, FIG. 7 is a schematic diagram of a seventh preferred embodiment of the method of the present invention that includes an optional Module G of the system software 19 that enables a creditor or other third party to determine the location of a specific asset or document where the RFID tag 14 includes a GPS circuit 50 whereby the RFID reader 50 can send the location to the network. An optional Module G of the system software 19 includes steps 701 through 703. In step 701 an RFID tag 14 is provided having a GPS circuit 50, the GPS circuit 50 informing the RFID tag 14 of a calculated location of the GPS circuit 50 as derived from transmissions received from the global positioning system. In step 502 the reader 10 reads the calculated location of the GPS circuit 50 from the RFID tag 14, and transmits the calculated location to one or more elements 6, 8, 22, 26, 30, 44, of the communications network 2. In step 703 the computer 8, or central server 8, provides the calculated location data to a filer 52 of a remote data base 54, the filer 52 being an electronic document that records information associated with the RFID tag 14.

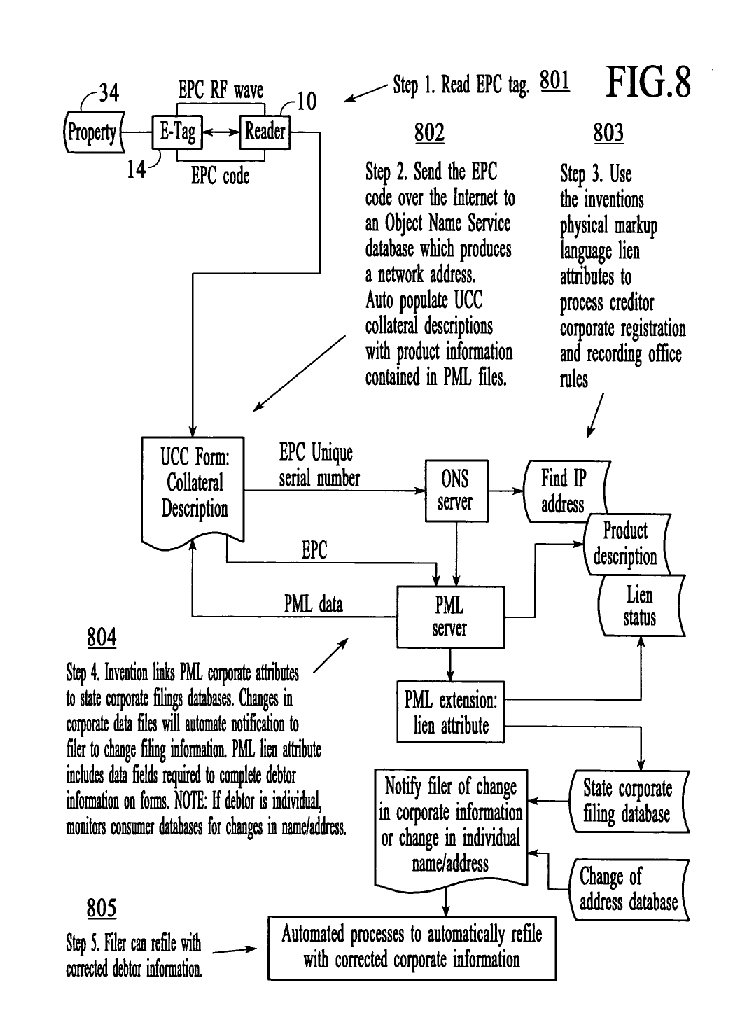

Referring now generally to the Figures, and particularly to FIG. 8, FIG. 8 is a schematic diagram of an eighth preferred embodiment of the method of the present invention that enables an originator of a lien transaction or record to utilize a computer network to validate the name, organizational identification, and address of the debtor by accessing databases of registered corporations, partnerships and LLCs for corporations; and validate individual debtor information through access of various databases maintaining consumer information and to notify the originator if changes in debtor information requires the UCC forms to be refilled. An optional Module H of the system software includes steps 801 through 805. In step 801 the reader 10 reads data from the RFID tag 14. In step 802 the EPC read from the RFID tag 14 by the reader 10 is transmitted by the computer 8 to the ONS server via the computer network 4. The ONS software 19 of the ONS server receives the EPC and finds one or more network addresses related to the EPC from a library of EPC and network address associations. The ONS then populate an electronic document with information associated with the EPC, such as descriptive information concerning the collateral 34, and optionally stores the information in a PML file or document. In step 803 lien attributes of the electronic document related to the EPC are accessed to locate creditor information associated with a creditor, where the creditor is named in an encumbrance filing that places the property 34 under an encumbrance. In step 804 the Module H links PML corporate attributes of a corporation associated with the encumbrance filing of step 803, to corporate records stored governmental or private corporate databases 56. Module H will then notify the filer 52 of changes of data stored in the corporate records and related to corporations associated with the EPC stored in the RFID tag 14. In step 805 a filer is resubmitted to an authority via the communications network 2 when the filer is provided with informing indicating a substantive of changes of data stored in the corporate records and related to corporations associated with the EPC stored in the RFID tag 14.

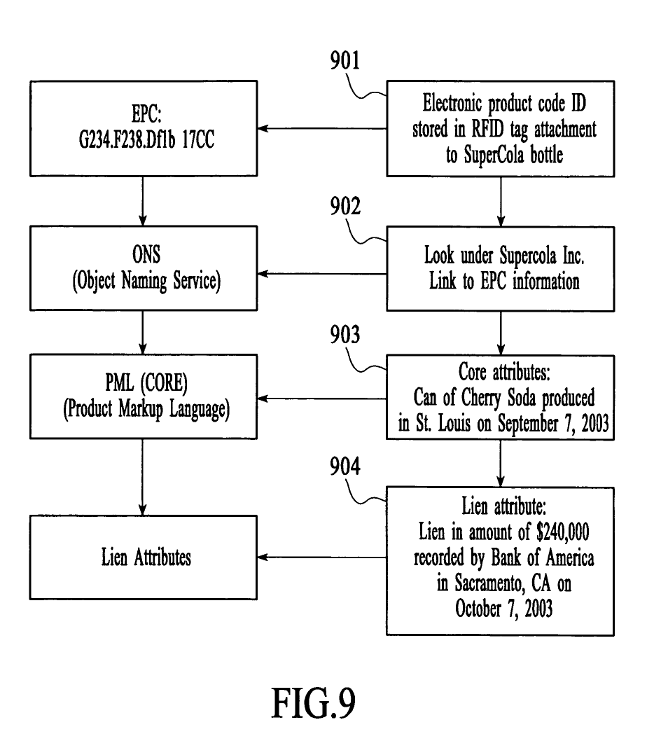

Referring now generally to the Figures, and particularly to FIG. 9, FIG. 9 is a schematic diagram of a ninth preferred embodiment of the method of the present invention wherein an RFID tag is affixed to an electronic chattel paper and identifies the document as the document created from electronic records and used to describe the collateral referred to in the filings. An optional Module I of the system software 19 includes steps 801 through 904. In step 901 an EPC stored in the RFID tag 14 is associated with property 34, e.g. a bottle designed to hold a SuperCola beverage. In step 902 the ONS is provided with the EPC via the RFID reader 10, computer 8, and the communications network 2. In step 803 the Module I accesses a PML document or file 58 of the PML server 30 wherein information associated with the EPC is stored in the PML document or file 58. In step 904 the Module I accesses lien attributes of the PML document or file 58 and provides information to a user via the communications network 2 regarding a lien placed against, or previously placed against the collateral 34.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

1. A method for owning and managing a system to monitor secured liens by associating a lien attribute with referenced collateral, the collateral having an electronic product code for uniquely identifying the collateral, the method comprising the use of one or more EPC technologies, to include an RFID tag, an electronic product code (“EPC”), an Object Name Service and a Physical Markup Language (“PML”), the method comprising:
completion and submission of lien forms by the inclusion of information about the debtor, the creditor, the collateral and the filing location associated with the EPC and a filing of an encumbrance upon the referenced collateral;
recording and maintaining the status of a secured lien by creating a lien record in a database of a computer;
associating the lien record with the EPC through PML; and
providing access by a user to the lien record upon receipt of a query specifying the electronic product code or the debtor via a computer network communicatively coupled with the database.

2. A method for owning and managing a system to monitor secured liens by associating a lien attribute with a property:
providing a computer network, the computer network including a user terminal, a data base server, and a bidirectional communications channel communicatively linking the user terminal and the data base server;
coupling a database having the lien record with the data base server;
associating an RFID tag with the property wherein the property is selected from the group of properties including an electronic record, a collateral, a secured collateral, a document describing secured collateral, and a financial encumbrance record forms; and
enabling the user terminal to provide access by the user to information associated of the property via the computer network.

3. The method of claim 3, wherein the method further comprises:
providing an RFID tag, the RFID tag having a memory, the memory storing the electronic product code related to the property;
providing an RFID reader, the RFID reader communicatively linked with the computer network;
reading the electronic product code from the RFID tag by the RFID reader;
passing the EPC number to a computer network Object Name Service telling the computer systems where to locate information on the network about the property carrying the EPC;
accessing the lien record and lien attributes defined as part of the PML associated with the electronic product code from the data base; and
providing access to the lien record by the user via the user terminal, the computer network, the data base server, and the database.

4. A system for associating a property with a financial encumbrance, the system comprising:
a computer network, the computer network comprising a user computer, a data base server, and a database, wherein the database is accessible to the computer network via the data base server;
a computer, the computer communicatively coupled with an RFID reader and the computer network;
an RFID tag, the RFID tag having a memory, the memory storing the electronic product code (“EPC”) related to the property;
the RFID reader for reading the EPC from the RFID tag and communicating the EPC to the computer network via the computer;
the computer network accessing a lien record and lien attributes associated with the EPC from the data base of the computer network; and
providing access to the lien record by the user via a user terminal, the computer network, the data base server, and the database.

5. One or more processor readable storage devices having readable code embodied on the processor readable storage devices, the readable code for programming one or more processors one to perform a method for owning and managing a system to monitor secured liens by associating a lien attribute with referenced collateral, the collateral having an electronic product code for uniquely identifying the collateral, the method comprising the use of one or more EPC technologies, to include an RFID tag, an electronic product code (“EPC”), an Object Name Service and a Physical Markup Language (“PML”), the method comprising:
completion and submission of lien forms by the inclusion of information about the debtor, the creditor, the collateral and the filing location associated with the EPC and a filing of an encumbrance upon the referenced collateral;
recording and maintaining the status of a secured lien by creating a lien record in a database of a computer;
associating the lien record with the EPC through PML; and
providing access by a user to the lien record upon receipt of a query specifying the electronic product code or the debtor via a computer network communicatively coupled with the database.
